(19) United States
(12) Patent Application Publication
(10) Pub. No.: US 2004/0033471 A1
(43) Pub. Date: Feb. 19, 2004

(54) Method for manufacturing the DP-bioglass to use in dental fracture repair via the carbon dioxide lasre

(76) Inventor: Feng Huei Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,712

(22) Filed: Aug. 13, 2002

(51) Int. Cl. A61C 5/00

(52) U.S. Cl. 433/228.1

(57) ABSTRACT

A method for manufacturing the DP-bioglass to use in dental fracture repair via the carbon dioxide lasre, the method comprises the steps: using an oxide material including a sodium, calcium, silicon and phosphate dehydrogenase composition; triturating the oxide material and drying it; heating the oxide material and rapid freezing; and drying the oxide material mixing with a phosphoric acid to react the DP-bioglass.

### BACKGROUND OF THE INVENTION

1. Field of the Invention

The present invention relate to a method for manufacturing the dental fracture repair material. More specifically, the present invention discloses a method using the DP-bioglass and carbon dioxide lasre to repair the dental fracture.

2. Description of the Prior Art

The problems of clinical medicine are a plurality of cracks of tooth surface. When the crack extended to the pulp chamber, the disease passes through the crack into the pulp chamber to generate catabolism. According to the catabolism, the tissue fluid flowed out of the pulp chamber via the paths being the cracks. Therefore, the cracks of teeth did not have much effect on people in the beginning. When the cracks begun to expand and fracture, the teeth faces to extraction.

The teeth can have more or less cracks being attributed to the crystalline fault of the micro structure and the port of tooth falling. The defects have a bad effect on stress distribution of tooth, and the stress concentration on the parts accelerates the breakage. The breakage of object results from the inside defects or cracks, and it is important to prevent the teeth structure defects and the cracks generated.

So far, the dental fracture repair material used amalgam alloy or composite resin. Before the cracks or cavities are fixed, the cracks or cavities have to trim leading to expand the material touching area for the material adhering on the tooth. But, the trim not only damages the fracture area second times but also reduces the strength of teeth, even though the cavities completely fixed but the strength of tooth could not recover original. It is continued research in micro cracks of tooth for improving the strength of tooth.

In 1969, the Hench disclosed the bioglass including the Na₂O—CaO—SiO₂—P₂O₅ composition could bond to the bones. So far, the clinical application bioglass only used in alveolar ridge rebuilding and the tympanum fixed.

The wide research used laser irradiation in enamel and dentin but only the argon laser used to enhance polymerization of complex resin in dental fracture repair research. In 1993, the Levy used the tricalcium phosphate mixing the 40 w.t. % phosphoric acid to be a dental fracture repair material filling into the cracks of tooth and irradiation of 10W, Nd-YAG laser. After the laser irradiated on the material, the volume of material got bigger and filled in the cracks via absorbing heat generating the solid-liquid phase transfer to reduce the bacteria, passing through the cracks and dentinal tubule, infecting the pulp chamber, according to the SEM and polarizing research microscope. Further more, in 1977; the Bipin and Kenneth used the HF laser irradiated the amalgam alloy, complex resin and glass ionomer cement finding the mechanical fracture generated.

### SUMMARY OF THE INVENTION

It is an object of the present invention is to provide a method for manufacturing the DP-bioglass to use in dental fracture repair via the carbon dioxide lasre that uses the DP-bioglass mixing the phosphoric acid to be a dental fracture repair material and does not need expansive equipment to mass production.

It is another object of the present invention is to provide a method for manufacturing the DP-bioglass to use in dental fracture repair via the carbon dioxide lasre that uses the DP-bioglass and combines carbon dioxide lasre to close the path of crack for preventing the micro cracks to expand.

The vertical crack of teeth resulted in the accidental hurt including the scuff and particular occlusion. In this situation, a little crack is attributed to extend to the root and crown. When the crack extended to the pulp chamber, the disease passes through the crack into the pulp chamber to generate catabolism. According to the catabolism, the tissue fluid flowed out of the pulp chamber via the paths being the cracks. It is important to prevent the crack extend or even breakage.

The present invention comprises a DP-bioglass mixing the phosphoric acid to be a dental fracture repair material being similar to the glass ionomer cement, and uses the carbon dioxide lasre to close the cracks. Further, the dental fracture repair material fills in the cracks of the tooth and reacts with the enamel and dentin to a calcium hydrogen phosphate(CaHPO₄.2H₂O). The crystalline phase between cracks and material is proof having the crosslink in room temperature. However, the calcium phosphate is not steady in mouth but it is transferred to calcium dihydrogen pyrophosphate(CaP₂O₇) by carbon dioxide lasre.

So far, the breakage teeth in clinical therapy mostly extracted the teeth or fixed with complex resin, the teeth mostly lost the ability of chew after therapy. The present invention discloses a method using the DP-bioglass to fill in cracks and carbon dioxide lasre to close, this process can completely prevent the micro crack to extend.

### BRIEF DESCRIPTION OF THE DRAWINGS

The above and further objects, features and advantages of the invention will become clear from the following more detailed description when read with reference to the accompanying drawings in which:

FIG. 1 shows a flow chart of the present invention;

FIG. 2 shows a X-ray diffraction pattern for DP-bioglass heating in different temperature of the present invention; and

FIG. 3 shows a X-ray coordinate diagram for Ca(H₂PO₄)₂.H₂O heating in different temperature of the present invention.

### DETAILED DESCRIPTION OF THE PREFERRED EMBODIMENTS

Before the micro cracks, carious teeth or cavities are fixed, the cracks, carious teeth or cavities have to trim but the trim not only damages the fracture area second times but also reduces the strength of teeth, even though the cavities completely fixed but the strength of tooth could not recover original. The present invention discloses using the laser to get the material and tooth to crosslink when the material fills in the cracks, and the teeth does not trim so that the material can steadily adhere on tooth for preventing the cracks to extend.

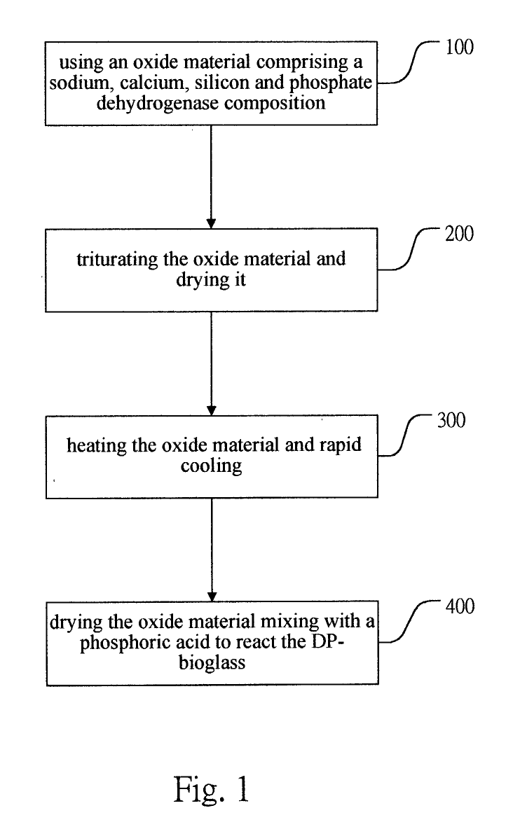

First, referring to FIG. 1, the present invention discloses a method for manufacturing the DP-bioglass to use in dental fracture repair via the carbon dioxide lasre, the method comprising the steps of:

Step 100, using an oxide material comprising a sodium, calcium, silicon and phosphate dehydrogenase composition;

Step 200, triturating the oxide material and drying it;

Step 300, heating the oxide material and rapid cooling; and

Step 400, drying the oxide material mixing with a phosphoric acid to react the DP-bioglass.

Wherein the sodium, calcium, silicon and phosphate dehydrogenase composition comprises a sodium carbonate(Na₂CO₃), calcium carbonate(CaCO₃), silicon dioxide(SiO₂) and calcium phosphate(Ca(PO₄)₂), and the composition ratio of Na₂O—CaO—SiO₂—PO₅ is 8.4%-40.6%-39.0%-12%. In Step 200, further comprising a step adds an organic solvent, for example, ethyl alcohol 80 to 120 ml, and the oxide material has to triturate 6 to 10 hours and dry at 70 to 90° C., 8 hours.

In step 300, the oxide material has to heat at 1410 to 1450° C., 1 to 2 hours. In step 400, the oxide material has to dry at 70 to 90° C., 24 hours, and uses 400 mesh sieve to get the particle required. Further, the DP-bioglass is a colloidal material to fill in the cracks of tooth using the carbon dioxide lasre at 4 to 6 Watts, 0.6 to 0.8 mm beam, 4 to 6 seconds irradiation time, 50 to 60 seconds total irradiation time and the carbon dioxide lasre with DP-bioglass interval is 0.5 to 1 mm.

The present invention discloses the DP-bioglass material with hydrogen ions of phosphoric acid processing an ion exchange, and according to X-ray crystalline phase analysis is a Ca(H₂PO₄).H₂O, the reactions as follows:

(SiO⁻)₂Ca²⁺+2H⁺+2H₂(PO₄)⁻+nH₂O→Ca(H₂(PO₄))₂.mH₂O+2Si—OH Si—OH+P₂O₅+H⁺+OH⁻→SiP₂O₇+H₂O

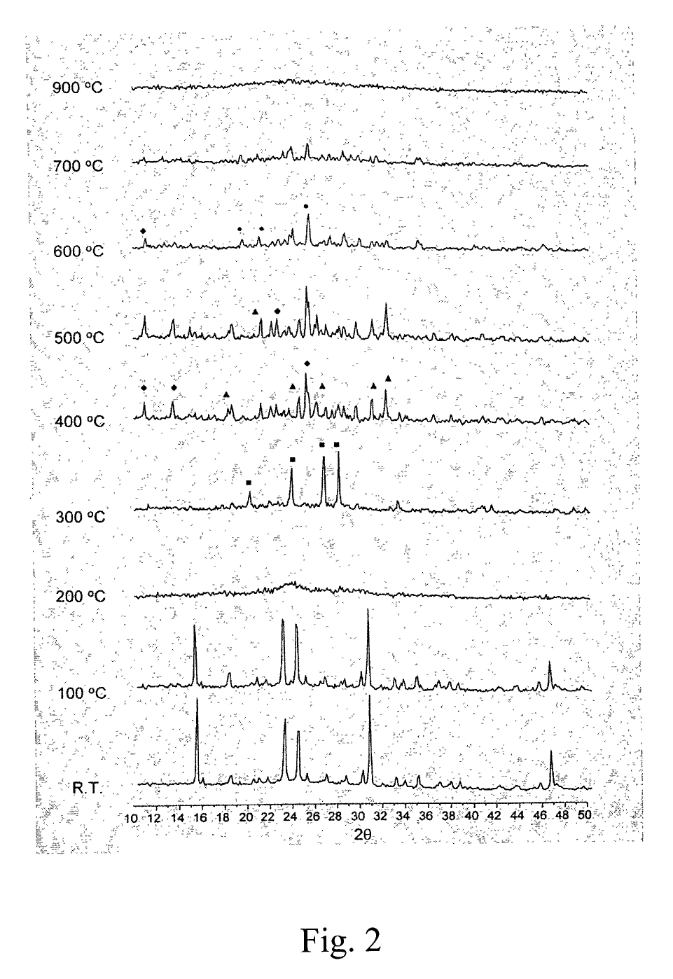

For understanding the DP-bioglass with carbon dioxide reaction, the DP-bioglass heats form room temperature to 1000° C. as 100° C. interval and maintains one hour to rapid freeze, referring to FIG. 2. The crystalline phase of DP-bioglass doses not change at 100° C. and shows the amorphous at 200° C. as well as it dehydrates to be a CaH₂P₂O₇ at 300° C. The CaH₂P₂O₇ dehydrates again to be a γ-CaP₂O₆ at 400° C. and the SiP₂O₇ with SiO₂ reacts to Si₃(PO₄)₄ coexisting with the γ-CaP₂O₆ in two-phases. The γ-CaP₂O₆ changes to a β-Ca(PO₃)₂ coexisting with the Si₃(PO₄)₄ at 400 to 600° C. and the material melts into a glass at 700 to 1000° C., the reactions as follows:

Ca(H₂PO₄)₂.H₂O→Ca(H₂PO₄)₂+H₂O—(100° C.)

Ca(H₂PO₄)₂→CaH₂P₂O₇+H₂O—(300° C.)

CaH₂P₂O₇→γ-CaP₂O₇+H₂O

SiP₂O₇+SiO₂→Si₃(PO₄)₄

γ-CaP₂O₆→β-Ca(PO₃)₂+H₂O

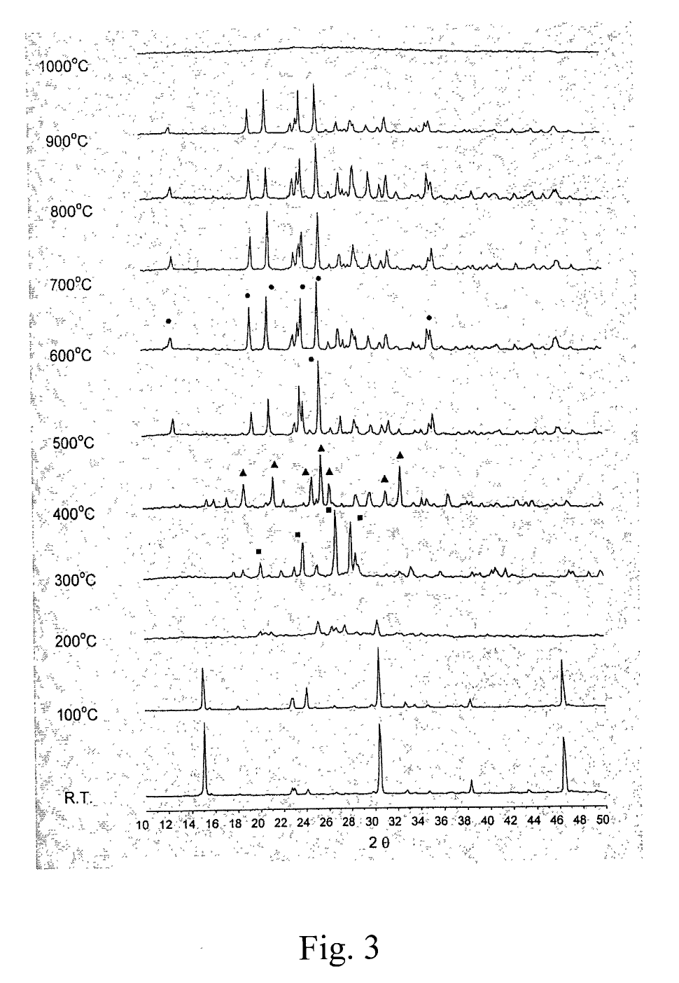

Referring to FIG. 3, the present invention discloses the Ca(H₂PO₄)₂. H₂O X-ray coordinate diagram in different temperature. The silicon-oxygen of glass reacts with the phosphoric acid to let the dental fracture material having silicon crystalline phase, and two phases existing so decrease the melting temperature that the material gets melting at 700° C. According to get the melting temperature down, the carbon dioxide lasre can melt in short time and at low temperature to create the crosslink.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method for manufacturing the DP-bioglass to use in dental fracture repair via the carbon dioxide lasre, the method comprising the steps:
using an oxide material including a sodium, calcium, silicon and phosphate acid salts composition;
triturating the oxide material and drying it;
heating the oxide material and rapid freezing; and
drying the oxide material mixing with a phosphoric acid to react the DP-bioglass.

2. The method according to claim 1, wherein said sodium, calcium, silicon and phosphate dehydrogenase composition are a sodium carbonate(Na₂CO₃), calcium carbonate(CaCO₃), silicon dioxide(SiO₂) and calcium phosphate(Ca(PO₄)₂).

3. The method according to claim 1, wherein said sodium, calcium, silicon and phosphate dehydrogenase composition is made of the composition ratio of Na₂O—CaO— SiO₂—PO₅ being 8.4%-40.6%-39.0%-12%.

4. The method according to claim 1, wherein triturating the oxide material further comprises a step:
adding a organic solvent.

5. The method according to claim 4, wherein said organic solvent is a ethyl alcohol.

6. The method according to claim 4, wherein adding organic solvent is 80 to 120 milliliters.

7. The method according to claim 1, wherein triturating time of said oxide material is 6 to 10 hours.

8. The method according to claim 1, wherein said triturating the oxide material and drying step heats at 70 to 90° C. in drying process.

9. The method according to claim 8, wherein drying step heats 8 hours.

10. The method according to claim 1, wherein said heating the oxide material step is at 1410 to 1450° C., 1 to 2 hours.

11. The method according to claim 1, wherein said rapid freezing step is at 70 to 90° C., 24 hours.

12. The method according to claim 1, wherein said drying the oxide material mixing with a phosphoric acid step uses a 400 mesh sieve to get a particle required for mixing with the phosphoric acid.

13. The method according to claim 1, wherein said phosphoric acid concentration is 65 w.t. % and adds 4 to 6 milliliters.

14. The method according to claim 1, wherein said DP-bioglass is a colloidal material.

15. The method according to claim 14, wherein said DP-bioglass fills in cracks of tooth and irradiates a carbon dioxide lasre.

16. The method according to claim 15, wherein said carbon dioxide lasre uses 4 to 6 Watts, 0.6 to 0.8 milliliters diameter of beam.

17. The method according to claim 15, wherein said irradiation time of carbon dioxide lasre is 4 to 6 seconds.

18. The method according to claim 15, wherein said total irradiation time of carbon dioxide lasre is 50 to 60 seconds.

19. The method according to claim 15, wherein said carbon dioxide lasre irradiating DP-bioglass distance is 0.5 to 1 milliliters.
